(19) United States
(12) Patent Application Publication
(10) Pub. No.: US 2011/0061815 A1
(43) Pub. Date: Mar. 17, 2011

(54) DEVICE FOR SENSING CURLED FILM IN LAMINATING MACHINE

(76) Inventor: Kuang-Hui CHOU, Taipei Hsien (TW)

(21) Appl. No.: 12/560,755

(22) Filed: Sep. 16, 2009

(51) Int. Cl. B32B 38/18

(52) U.S. Cl. 156/378

(57) ABSTRACT

A device for sensing a curled film in a laminating machine essentially includes rollers and a photoelectric sensor disposed behind the rollers. Working on the principle that reflectance varies with surfaces of different objects, the photoelectric sensor continuously projects a visible or invisible light onto surfaces of the rollers. When there is a foreign matter on the rollers, or when a laminating film is curled around one of the rollers, the intensity of reflected light received by the photoelectric sensor changes. The change of intensity is converted by means of the photoelectric sensor and related circuits into a change of voltage so as to activate a safety mechanism, which includes giving off an alarm and ejecting the to-be-laminated object. Thus, not only is the motor of the laminating machine prevented from burning, but also the to-be-laminated object is protected from damage.

### BACKGROUND OF THE INVENTION

1. Technical Field

The present invention relates to a device for sensing a curled film in a laminating machine and, more particularly, to a device for sensing if a to-be-laminated object adheres to rollers in a laminating machine.

2. Description of Related Art

Lamination is widely used for document preservation and is carried out in the following manner. Photographs or other planar objects of importance (e.g., paper-based pictures or documents) are sandwiched between laminating films to form a to-be-laminated object, which is then fed into a laminating machine so as to be hot-pressed and completely sealed. Thus, the important materials, such as photographs and pictures, inside the resultant laminate are tightly enclosed by the laminating films and protected against moisture and damage.

However, there is a tremendous risk when the to-be-laminated object containing the document undergoes lamination. This is because a document needing lamination must be of consequence, worth preservation, and in most cases the only copy in existence. Should a mistake occur during the laminating process, the important document, which is very likely the only existing copy, may be damaged. Now that mistakes are inevitable, a laminating machine must be provided with certain safety measures to prevent important documents from being ruined by accident.

Presently, the most frequent cause of document damage by a laminating machine is adjusting the hot-press temperature too high, which makes laminating films adhere to and get stuck between the rollers so that the document between the laminating films is damaged. Another highly probable cause is inserting the to-be-laminated object in a wrong direction. Referring to FIG. 6, a to-be-laminated object 50 is composed essentially of an upper laminating film 501, a lower laminating film 502, and a document 503 sandwiched therebetween. As the upper laminating film 501 and the lower laminating film 502 are already sealed together at one end, the document 503 usually has one end pushed against the seal end of the upper and lower laminating films 501, 502. The sealed end also serves as a leading end 51 when the to-be-laminated object 50 is inserted into the laminating machine for lamination. If the to-be-laminated object 50 is inadvertently inserted in a reverse direction, i.e., with a rear end 52 going in first, as indicated by the dash-line arrow in FIG. 6, the to-be-laminated object 50 will touch the rollers of the laminating machine with the rear end 52. Therefore, when hot-pressed by the rollers, the to-be-laminated object 50 may be curled around the rollers instead of advancing along a tangential direction thereof. It is very likely that the beginning section of the to-be-laminated object 50 will be enough to get the rollers stuck so that the motor runs without load thereafter. Eventually, related circuits will be burnt, or the laminating machine itself is damaged, thereby crunching or even destroying the precious document to be laminated.

While it is necessary to adjust the hot-press temperature according to the size of the to-be-laminated object, and the to-be-laminated object is always subject to the possibility of being unintentionally fed in a wrong direction, any such mistake may damage the document which is supposed to be protected by lamination. Therefore, it is imperative that a laminating machine be equipped with an effective sensing device to prevent losses caused by operational mistakes.

### BRIEF SUMMARY OF THE INVENTION

It is a primary objective of the present invention to provide a design which, upon occurrence of a to-be-laminated object being curled around rollers of a laminating machine, is capable of detecting the occurrence immediately, providing an alert, and rotating the rollers reversely so as to eject the to-be-laminated object safely.

To achieve the above and other objectives, the present invention provides a device for sensing a curled film in a laminating machine, wherein the device essentially includes rollers and a photoelectric sensor disposed behind the rollers. Working on the principle that reflectance varies with surfaces of different objects, the photoelectric sensor continuously projects a visible or invisible light onto surfaces of the rollers. When there is a foreign matter on the rollers, or when a laminating film is curled around one of the rollers, the intensity of reflected light received by the photoelectric sensor changes. The change of intensity is converted by means of the photoelectric sensor and related circuits into a change of voltage so as to activate a safety mechanism, which includes giving off an alarm and ejecting the to-be-laminated object. Thus, not only is the motor of the laminating machine prevented from burning, but also the to-be-laminated object is protected from damage.

### BRIEF DESCRIPTION OF THE SEVERAL VIEWS OF THE DRAWINGS

The invention as well as a preferred mode of use, further objectives, and advantages thereof will be best understood by referring to the following detailed description of an illustrative embodiment in conjunction with the accompanying drawings, wherein:

FIG. 1 is a sectional view of a laminating machine using a device of the present invention for sensing a curled film in the laminating machine;

FIG. 2 is a top view of the laminating machine illustrated in FIG. 1;

FIG. 3 is another sectional view of the laminating machine illustrated in FIG. 1, wherein the lamination machine is in normal operation;

FIG. 4 is yet another sectional view of the laminating machine illustrated in FIG. 1, wherein a to-be-laminated object is curled around a roller;

FIG. 5 is still another sectional view of the laminating machine illustrated in FIG. 1, showing how the device of the present invention solves the problem presented in FIG. 4;

FIG. 6 is a perspective view of a to-be-laminated object; and

FIG. 7 is a flowchart showing operation of the device of the present invention.

### DETAILED DESCRIPTION OF THE INVENTION

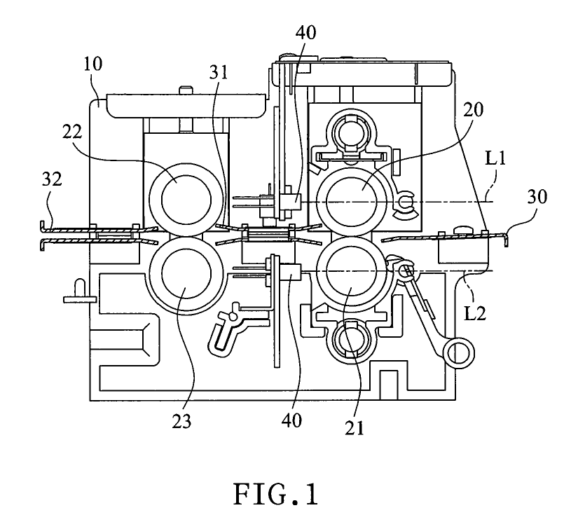

Please refer to FIGS. 1, 2, and 3 for a laminating machine. A set of front rollers 20, 21 and a set of rear rollers 22, 23 are provided in a machine body 10 of the laminating machine and properly spaced from each other. The front rollers 20, 21 and the rear rollers 22, 23 are driven, through gear transmission, by a power unit 11 provided on a lateral side of the machine body 10, so as to rotate in predetermined directions.

A front guiding member 30, an intermediate guiding member 31, and a rear guiding member 32 are disposed in front of the front rollers 20, 21; between the front rollers 20, 21 and the rear rollers 22, 23; and behind the rear rollers 22, 23; respectively. The guiding members are intended to guide and support a to-be-laminated object 50 and ensure that the to-be-laminated object 50 moves smoothly along the correct directions.

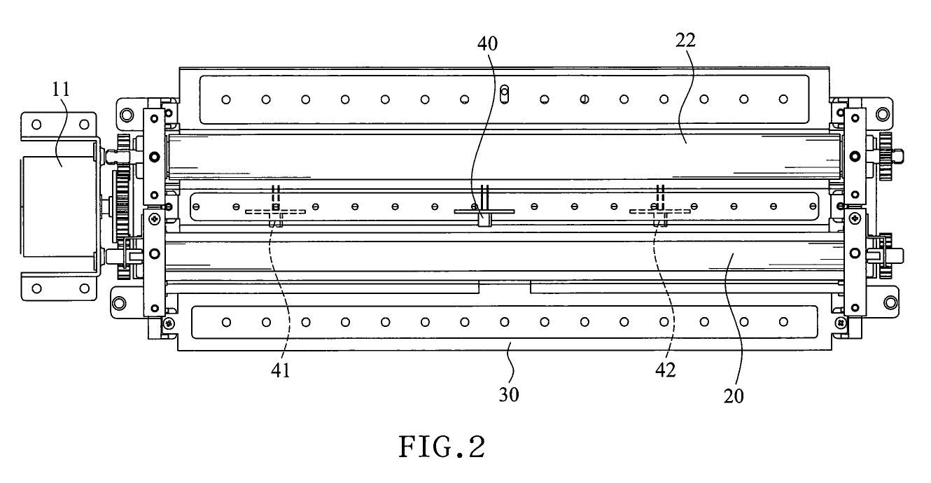

At least one photoelectric sensor 40 is provided behind one of the front rollers 20, 21. In an embodiment of the present invention, three sets of photoelectric sensors 40, 41, 42 are provided, as shown in FIG. 2. Depending on the width of the machine body 10 of the laminating machine, the number of the photoelectric sensors 40, 41, 42 may be increased. Furthermore, in order to provide timely sensing, the photoelectric sensors 40, 41, 42 are preferably located on horizontal centerlines L1, L2 extending rearward from the front rollers 20, 21. As shown in FIG. 1, two photoelectric sensors 40 are provided respectively on the horizontal centerlines L1, L2 extending rearward from the upper and lower front rollers 20, 21.

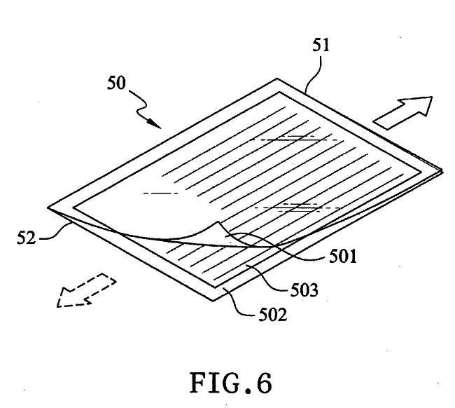

Referring to FIG. 6, the to-be-laminated object 50 is composed mainly of an upper laminating film 501, a lower laminating film 502, and a document 503 sandwiched therebetween. The upper laminating film 501 and the lower laminating film 502 are sealed together at one end in advance, and the document 503 is pushed against the sealed end of the upper and lower laminating films 501, 502. The sealed end also serves as a leading end 51 when the to-be-laminated object 50 is inserted into the laminating machine for lamination. If the to-be-laminated object 50 is inserted reversely by mistake, i.e., along a direction indicated by the dash-line arrow in FIG. 6, the to-be-laminated object 50 tends to advance with difficulty or get stuck. And these problematic scenarios are exactly what the present invention aims to solve.

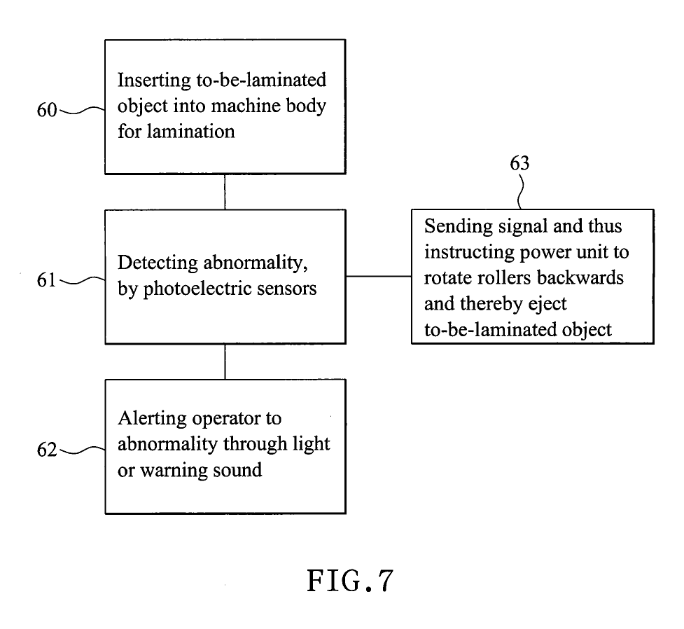

Referring to FIG. 7, the effects of the present invention is achieved by the following steps.

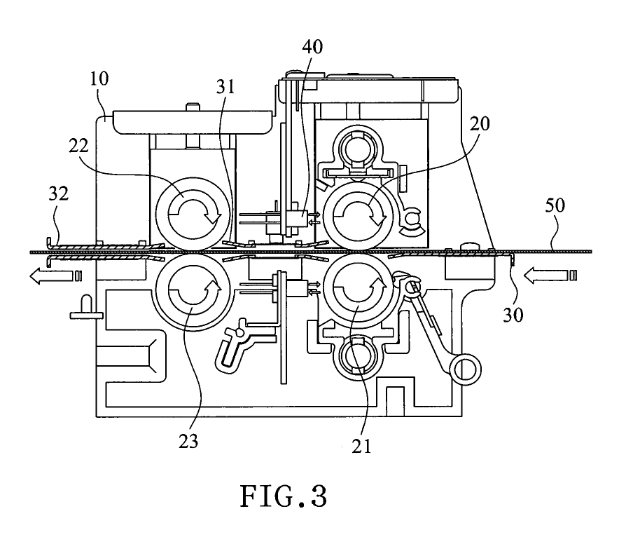

At step 60, as shown in FIGS. 3 and 7, the to-be-laminated object 50 is placed into the machine body 10 for lamination. Normally, the to-be-laminated object 50 is inserted with the leading end 51 going in first, and the laminating process is completed after the to-be-laminated object 50 is heated and pressed by the front rollers 20, 21 and the rear rollers 22, 23 successively.

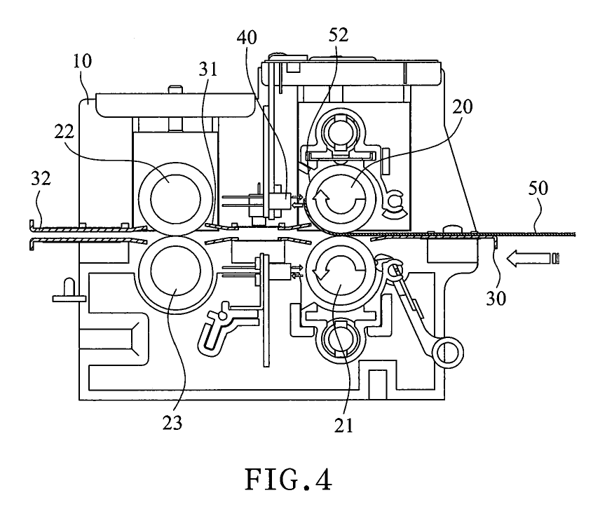

At step 61, referring to FIGS. 4 and 7, the photoelectric sensors 40 detect an abnormality. More specifically, if the to-be-laminated object 50 is incorrectly oriented such that a rear end 52 thereof (as shown in FIG. 6) is entrained by and wrapped around one of the front rollers 20, 21, or if the heating temperature is so high that the to-be-laminated object 50 adheres to the front rollers 20, 21, the intensity of reflected light received by the photoelectric sensors 40 will change as soon as the to-be-laminated object 50 moves past one of the horizontal centerlines L1, L2. The photoelectric sensors 40 sense the change of intensity and thus detect the abnormality.

At step 62, the photoelectric sensors 40 immediately alert the operator to the abnormality through light or a warning sound.

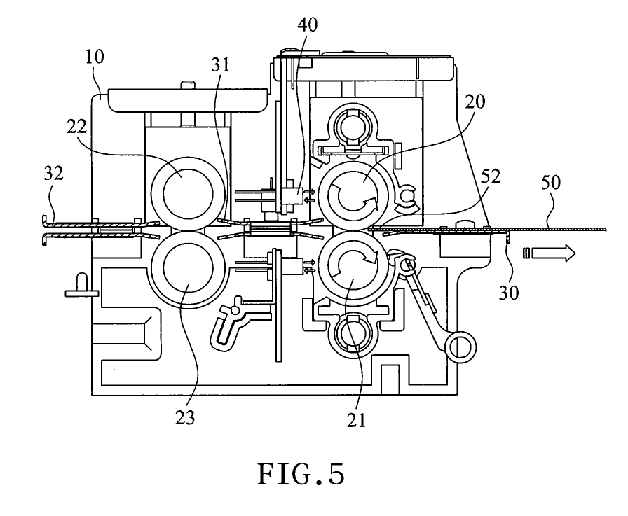

At step 63, referring to FIGS. 5 and 7, the photoelectric sensors 40 send a signal to the power unit 11, instructing the power unit 11 to rotate the front rollers 20, 21 reversely so as to eject the to-be-laminated object 50.

Hence, according to the present invention, when a to-be-laminated object is curled around one of the front rollers during operation because of an excessively high heating temperature, a wrong inserting direction, or any other reasons, the photoelectric sensors immediately detect the abnormality, provide an alert, and have the front rollers rotated reversely to eject the to-be-laminated object. The major advantage of the present invention is that, while the to-be-laminated object is safely ejected, the motor of the laminating machine is also prevented from burning.

The present invention is described herein by reference to the preferred embodiment. However, it is understood that the embodiment is not intended to limit the scope of the present invention, and equivalent or minor changes to the disclosed embodiment are easily conceivable by a person skilled in the art.

For example, as the type and size of the laminating machine vary, the rollers may be increased in number or reduced to only one set. In other words, the number of the rollers may be easily changed without departing from the scope of the present invention.

Furthermore, the number and locations of the photoelectric sensors may also vary without departing from the scope of the present invention.

Therefore, all equivalent alterations and modifications, as well as addition of accessories and change of materials, which do not depart from the concept and scope of the present invention should be encompassed by the appended claims.

In short, the present invention is capable of achieving the intended effects, has not been put to public use, demonstrates industrial applicability, and thus meets the requirements of novelty and utility for patent application. Therefore, an application for patent of the present invention is hereby lawfully filed for examination.

What is claimed is:

1. A device for sensing a curled film in a laminating machine, the device comprising:
a set of rollers provided in a machine body of the laminating machine, wherein the rollers are driven to rotate in predetermined directions by a power unit provided on a lateral side of the machine body;
at least a guiding member provided in front of the rollers; and
at least a photoelectric sensor provided behind one of the rollers and configured for sensing if a to-be-laminated object is curled up.

2. The device of claim 1, wherein there are a plurality of said photoelectric sensors.

3. The device of claim 1, wherein the at least a photoelectric sensor is located on horizontal centerlines extending rearward from the rollers.

4. The device of claim 1, wherein the set of rollers comprises an upper roller and a lower roller.

5. The device of claim 1, wherein there are plural sets of said rollers.

6. The device of claim 1, wherein there are a plurality of said guiding members.
